(19) United States
(12) Patent Application Publication
(10) Pub. No.: US 2009/0137741 A1
(43) Pub. Date: May 28, 2009

(54) THERMOPLASTIC ELASTOMER COMPOSITION, COMPOSITE MOLDED BODY AND WEATHER STRIP

(75) Inventor: Nobuhiro NATSUYAMA, Ichihara-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED, Tokyo (JP)

(21) Appl. No.: 12/273,583

(22) Filed: Nov. 19, 2008

(30) Foreign Application Priority Data
Nov. 28, 2007 (JP) 2007-307041

(51) Int. Cl. C08L 23/06; C08L 23/00; C08L 23/12

(52) U.S. Cl. 525/194; 525/192

(57) ABSTRACT

The present invention provides a thermoplastic elastomer composition, a composite molded body and a weather strip. The thermoplastic elastomer composition comprises the following (i) and (ii): (i) a thermoplastic elastomer obtained by dynamically crosslinking (a), (b), (c) and (d) in the presence of a crosslinking agent,(a) 10 to 75% by weight of the ethylene-a-olefin copolymer rubber; (b) 10 to 50% by weight of a propylene resin; (c) 5 to 60% by weight of mineral oil; and (d) an ethylene resin; a total content of (a), (b) and (c) being 100% by weight, and a content of (d) being from 0 to 10 parts by weight, provided that the total content of (a), (b) and (C) is 100 parts by weight; (ii) a high density polyethylene; and a content of (ii) is from 55 to 150 parts by weight based on 100 parts by weight of (a) the ethylene-α-olefin copolymer rubber.

### TECHNICAL FIELD

The present invention relates to a thermoplastic elastomer composition, a composite molded body and a weather strip.

### BACKGROUND ART

Components requiring rubber elasticity used as automobile components, industrial machine components, electric/electronic components, etc., such as a weather strip, a door trim and a gasket, have been made of vulcanized rubber molded bodies obtained by vulcanizing ethylene/propylene/nonconjugated diene copolymer rubber (EPDM). In a method for producing a molded body having, for example, a straight portion and a curved portion, a straight member made of vulcanized rubber is molded by extrusion vulcanization molding, and a curved member is then molded by performing vulcanization for several minutes with the straight member set in a die and with EPDM injected into the die, and thus, a composite molded body including the straight member and the curved member jointed to each other is molded.

These days, a thermoplastic elastomer is used to be injected into a die instead of the EPDM for improving the productivity, and a production method not requiring the conventional vulcanization of the EPDM injected into a die is being studied. Furthermore, since a conventional thermoplastic elastomer is not sufficient in adhesion to vulcanized rubber, examination is being made on a thermoplastic elastomer good at the adhesion to vulcanized rubber. For example, JP-A-2003-147133 describes a thermoplastic elastomer obtained by dynamically crosslinking ethylene-a-olefin copolymer rubber, a propylene resin and high density polyethylene in the presence of an organic oxide.

The thermoplastic elastomer is, however, insufficient in the adhesion to vulcanized rubber.

### DISCLOSURE OF THE INVENTION

Under these circumstances, a thermoplastic elastomer good at the adhesion to vulcanized rubber has been earnestly studied, resulting in achieving the present invention.

Specifically, the present invention provides a thermoplastic elastomer composition comprising the following (i) and (ii);

(i) a thermoplastic elastomer obtained by dynamically crosslinking (a), (b), (C) and (d) in the presence of a crosslinking agent,
(a) 10 to 75% by weight of the ethylene-α-olef in copolymer rubber;
(b) 10 to 50% by weight of a propylene resin;
(c) 5 to 60% by weight of mineral oil; and
(d) an ethylene resin;
a total content of (a), (b) and (c) being 100% by weight, and a content of (d) being from 0 to 10 parts by weight, provided that the total content of (a), (b) and (c) is 100 parts by weight;

(ii) a high density polyethylene; and
a content of (ii) is from 55 to 150 parts by weight based on 100 parts by weight of (a) the ethylene-α-olefin copolymer rubber.

The present invention provides a composite molded body comprising a molded body made of the above-described composition and a vulcanized rubber molded body jointed to each other.

Furthermore, the present invention provides a weather strip comprising a molded body made of the above-described composition and a vulcanized rubber molded body jointed to each other.

### MODE OF CARRYING OUT THE INVENTION

### Thermoplastic Elastomer Composition

The thermoplastic elastomer composition of the present invention includes (i) a thermoplastic elastomer and (ii) a high density polyethylene.

### (i) Thermoplastic Elastomer

The thermoplastic elastomer is obtained by dynamically crosslinking (a) ethylene-α-olefin copolymer rubber, (b) a propylene resin, (c) mineral oil and optionally (d) an ethylene resin in the presence of a crosslinking agent.

(a) Ethylene-α-olefin Copolymer Rubber

The ethylene-α-olefin copolymer rubber is a copolymer that includes a monomer unit based on ethylene (ethylene unit) and a monomer unit based on α-olefin having 3 to 10 carbons (α-olefin unit having 3 to 10 carbons) and has an JIS-A hardness in accordance with JIS K-6253 of not more than 85. Examples of the α-olefin having 3 to 10 carbons include propylene, 1-butene, 2-methyl propylene, 1-pentene, 3-methyl-1-butene, 1-hexene, 4-methyl-1-pentene and 1-octene, and one of them may be singly used, or two or more of them may be used together. From the viewpoint of availability, propylene and 1-butene are preferably used and propylene is more preferably used.

The ethylene-α-olefin copolymer rubber may include another monomer unit in addition to the ethylene unit and the α-olefin unit having 3 to 10 carbons. Examples of a monomer used for such another monomer unit include conjugated diene having 4 to 8 carbons, such as 1,3-butadiene, 2-methyl-1,3-butadiene (isoprene), 1,3-pentadiene or 2,3-dimethyl-1,3-butadiene; nonconjugated diene having 5 to 15 carbons, such as dicyclopentadiene, 5-ethylidene-2-norbornene, 1,4-hexadiene, 1,5-dicyclooctadiene, 7-methyl-1,6-octadiene or 5-vinyl-2-norbornene; a vinyl ester compound such as vinyl acetate; unsaturated carboxylate such as methyl acrylate, ethyl acrylate, butyl acrylate, methyl methacrylate or ethyl methacrylate; and an unsaturated carboxylic acid such as acrylic acid or methacrylic acid, and one of them may be singly used, or two or more of them may be used together. From the viewpoint of availability, 5-ethylidene-2-norbornene or dicyclopentadiene is preferably used.

The ethylene-α-olefin copolymer rubber has an ethylene content, which is the content of the ethylene unit, of usually 30 to 85% by weight, preferably 40 to 80% by weight; an α-olefin content, which is the content of the α-olefin unit having 3 to 10 carbons, of usually 5 to 70% by weight, preferably 15 to 60% by weight; and usually 0 to 30% by weight, preferably 0 to 20% by weight of another monomer unit other than the ethylene unit and the α-olefin unit, provided that the total content of these units is 100% by weight.

Examples of the ethylene-α-olefin copolymer rubber include ethylene-propylene copolymer rubber, ethylene-1-butene copolymer rubber, ethylene-1-hexene copolymer rubber, ethylene-1-octene copolymer rubber, ethylene-propylene-1-butene copolymer rubber, ethylene-propylene-1-hexene copolymer rubber, ethylene-propylene-1-octene copolymer rubber, ethylene-propylene-5-ethylidene-2-norbornene copolymer rubber, ethylene-propylene-dicyclopentadiene copolymer rubber, ethylene-propylene-1,4-hexadiene copolymer rubber and ethylene-propylene-5-vinyl-2-norbornene copolymer rubber. One of them may be singly used, or a combination of two or more of them may be used. In particular, an ethylene-propylene copolymer rubber or an ethylene-propylene-5-ethylidene-2-norbornene copolymer rubber preferably has an ethylene content of 40 to 80% by weight, a propylene content of 15 to 60% by weight, an ENB content, which is the content of the 5-ethylidene-2-norbornene unit, of 0 to 20% by weight.

The ethylene-α-olefin copolymer rubber has a Mooney viscosity (ML₁₊₄100° C.) of preferably not less than 10, more preferably not less than 30 from the viewpoint of improvement in the mechanical strength of a molded body. Furthermore, the ethylene-α-olefin copolymer rubber has a Mooney viscosity (ML₁₊₄100° C.) of preferably not more than 350, more preferably not more than 300 from the viewpoint of improvement in the appearance of the molded body. It is noted that the Mooney viscosity (ML₁₊₄100° C.) is measured in accordance with JIS K6300,

The ethylene-α-olefin copolymer rubber has an intrinsic viscosity measured in tetralin at 135° C. of preferably not less than 0.5 dl/g, more preferably not less than 1 dl/g from the viewpoint of improvement in the mechanical strength of the molded body. Furthermore, the ethylene-α-olefin copolymer rubber has an intrinsic viscosity of preferably not more than 8 dl/g, more preferably not more than 6 dl/g from the viewpoint of improvement in the appearance of the molded body.

The ethylene-α-olefin copolymer rubber may be produced by a conventional method.

### (b) Propylene Resin

The propylene resin is a polymer including 50 to 100% by weight, preferably 80 to 100% by weight of a monomer unit based on propylene (propylene unit), provided that a polymer has a content of 100% by weight. Examples of the propylene resin include a propylene homopolymer, and a copolymer of propylene and at least one selected from the comonomer group consisting of ethylene and α-olefin having 4 to 10 carbons (such as 1-butene, 1-hexene, 1-pentene, 1-octene or 4-methyl-1-pentene). The copolymer may be a random copolymer or a block copolymer. More specifically, examples of the copolymer include a propylene-ethylene copolymer, a propylene-1-butene copolymer, a propylene-1-hexene copolymer, a propylene-1-octene copolymer, a propylene-ethylene-1-butene copolymer and an ethylene-propylene-1-hexene copolymer. The propylene resin is preferably a propylene homopolymer, a propylene-ethylene copolymer or a propylene-1-butene copolymer.

Examples of the steric structure of the propylene resin include an isotactic structure, a syndiotactic structure and a mixed structure of these structures. Preferably, the principal structure is the isotactic structure.

The propylene resin can be produced by a conventional polymerization method using, as a polymerization catalyst, Ziegler-Natta catalyst, metallocene catalyst or the like. Examples of the polymerization method include solution polymerization, bulk polymerization, slurry polymerization and vapor phase polymerization, and a combination of two or more of them may be used.

The propylene resin has a melt flow rate (measured in accordance with JIS K7210 under load of 21.18 N at a temperature of 230° C.) of preferably 0.1 to 300 g/10 min., more preferably 0.5 to 200 g/10 min.

### (c) Mineral Oil

Examples of the mineral oil include aromatic mineral oil, naphthenic mineral oil and paraffinic mineral oil, preferably paraffinic mineral oil. The mineral oil preferably has an average molecular weight of 300 to 1500 and a flow point of not more than 0° C.

In mixing the mineral oil, oil-extended ethylene-α-olefin copolymer rubber in which a mineral oil is mixed in ethylene-α-olefin copolymer rubber may be used. Examples of a method for mixing the mineral oil in the ethylene-α-olefin copolymer rubber include (1) a method in which they are mechanically kneaded by using a kneader such as a roll or a Banbury mixer and (2) a method in which the mineral oil is added to a solution including a solvent and the ethylene-α-olefin copolymer rubber, and then the solvent is removed from the resultant by steam stripping or the like.

### (d) Ethylene Resin

The ethylene resin is a polymer including 85 to 100% by weight of a monomer unit based on ethylene (ethylene unit), provided that a polymer has a content of 100% by weight. Examples of the ethylene resin include an ethylene homopolymer, a copolymer of ethylene and at least one of α-olefins having 3 to 10 carbons (such as propylene, 1-butene, 1-pentene, 4-methyl-1-pentene and 1-hexene), and a copolymer of ethylene and at least one of polar monomers (such as vinyl acetate, acrylate and methacrylate). Preferable examples of the ethylene resin include high density polyethylene, low density polyethylene, ethylene-propylene copolymer, ethylene-1-butene copolymer, ethylene-1-pentene copolymer, ethylene-4-methyl-1-pentene copolymer and ethylene-1-hexene copolymer.

The ethylene resin has a melt flow rate (measured in accordance with JIS K6760 under load of 21.18 N at a temperature of 190° C.) of preferably 0-01 to 300 g/10 min., more preferably 0.1 to 200 g/10 min.

### (ii) High Density Polyethylene

The high density polyethylene is a polymer that includes 90 to 100% by weight of a monomer unit based on ethylene (ethylene unit) and has a density measured in accordance with JIS K7112 of not less than 940 kg/m³, provided that a polymer has a content of 100% by weight.

The high density polyethylene has a melt flow rate (measured in accordance with JIS K6760 under load of 21.18 N at a temperature of 190° C.) of preferably 0.01 to 300 g/10 min., more preferably 0.1 to 200 g/10 min., further preferably 0.5 to 50 g/10 min., furthermore preferably 1 to 10 g/10 min.

The high density polyethylene can be produced by a conventional polymerization method using, as a polymerization catalyst, Ziegler-Natta catalyst, metallocene catalyst or the like. Examples of the polymerization method include solution polymerization, bulk polymerization, slurry polymerization and the vapor phase polymerization, and a combination of two or more of them may be used.

### Crosslinking Agent and Others

The crosslinking agent may be any of crosslinking agents conventionally used for crosslinking rubber. Examples of crosslinking agent include an organic peroxide, a phenol resin, sulfur, a sulfur-containing compound, p-quinone, a derivative of p-quinonedioxime, a bismaleimide compound, an epoxy compound, a silane compound and amino resin, preferably an organic peroxide.

Examples of the organic peroxide include dicumyl peroxide, di-tert-butyl peroxide, 2,5-dimethyl-2,5-di(tert-butyl peroxy) hexane, 2,5-dimethyl-di(tert-butyl peroxy) hexyne-3,1,3-bis(tert-butyl peroxyisopropyl) benzene, 1,1-bis(tert-butyl peroxy)-3,3,5-trimethylcyclohexane, n-butyl-4,4-bis(tert-butyl peroxy) valerate, benzoyl peroxide, p-chlorobenzoyl peroxide, 2,4-dichlorobenzoyl peroxide, tert-butyl peroxy benzoate, tert-butyl peroxy isopropyl carbonate, diacetyl peroxide, lauroyl peroxide and tert-butyl peroxide; preferably 2,5-dimethyl-2,5-di(tert-butyl peroxy)-hexyne-3,2,5-dimethyl-2,5-di(tert-butyl peroxy) hexane and 1,3-bis(tert-butyl peroxy isopropyl) benzene, more preferably 2,5-dimethyl-2,5-di(tert-butyl peroxy)-hexyne-3. The organic peroxide may be in any form of liquid, powder, pellet or the like.

Furthermore, it may be diluted, before use, with a diluent inactive to the crosslinking reaction, such as an inorganic filler, mineral oil or a solvent. From the viewpoint of improvement in dispersibility of the organic peroxide in the dynamic crossIinking reaction, the organic peroxide is included preferably in the form of a liquid, and more preferably, the organic peroxide is diluted, before use, with paraffinic oil.

In order to proceed the crosslinking reaction homogeneously and gently, a crosslinking assistant may be used in combination with the organic peroxide. As the crosslinking assistant, a poly-functional compound of sulfur base, methacrylate base or maleimide base can be used. Examples of the crosslinking assistant include sulfur, p-quinonedioxime, p,p′-dibenzoyl quinonedioxime, ethylene glycol dimethacrylate, diethylene glycol dimethacrylate, triethylene glycol dimethacrylate, tetraethylene glycol dimethacrylate, polyethylene glycol dimethacrylate, trimethyrol propane trimethacrylate, diallyl phthalate, tetraallyl oxyethane, triallyl isocyanurate, N,N′-m-phenylenebismaleimide, maleic anhydride, divinyl benzene, zinc diacrylate and zinc dimethacrylate. In particular, N,N′-m-phenylene bismaleimide, p,p′-dibenzoyl quinonedioxime, divinyl benzene, trimethyrol propane trimethacrylate or triallyl isocyanurate is preferred. N,N′-m-phenylene bismaleimide may be singly used as the crosslinking agent.

Examples of the phenol resin used as the crosslinking agent include a compound represented by the following formula which is conventionally used as a crosslinking agent for rubber (see U.S. Patent Nos. 3,287,440 and 3,709,840):

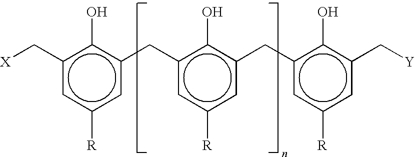

wherein n is an integer of 0 to 10; X and Y are independently a hydroxyl group, an alkyl halide group or a halogen atom; and R is a saturated hydrocarbon group having 1 to 15 carbons. This compound can be produced by condensation polymerization of substituted phenol and aldehyde in the presence of an alkali catalyst.

Examples of the phenol resin include alkyl phenol formaldehyde and brominated alkyl phenol formaldehyde.

When the phenol resin is used as the crosslinking agent, a crosslinking accelerator may be used in combination for adjusting the speed of the crosslinking reaction. Examples of the crosslinking accelerator include a metallic halide such as tin chloride or ferric chloride; and an organic halide such as chlorinated polypropylene, butyl bromide rubber or chloroprene rubber.

The phenol resin is preferably used in combination with a dispersant such as a metal oxide (for example, zinc oxide) or stearic acid.

The thermoplastic elastomer composition may be produced by a method including the steps of;

dynamically crosslinking (a), (b), (c) and (d) in the presence of a crosslinking agent to obtain (i) an thermoplastic elastomer,
(a) 10 to 75% by weight of the ethylene-α-olefin copolymer rubber;
(b) 10 to 50% by weight of a propylene resin;
(c) 5 to 60% by weight of mineral oil; and
(d) an ethylene resin;
a total content of (a), (b) and (c) being 100% by weight, and a content of (d) being from 0 to 10 parts by weight, provided that the total content of (a), (b) and (c) is 100 parts by weight;

mixing the thermoplastic elastomer with (ii) a high density; and
a content of (ii) is from 55 to 150 parts by weight based on 100 parts by weight of (a) the ethylene-α-olefin copolymer rubber.

The “dynamic crosslinking” means a treatment in which the ethylene-α-olefin copolymer rubber, the propylene resin, the mineral oil and another component added if necessary are melt-kneaded in the presence of the crosslinking agent with shearing force applied. The dynamic crosslinking can be performed with an open type mixing roll; or a conventional melt-kneading machine such as a closed type Banbury mixer, an extrusion kneader, a kneader or a continuous mixer. In particular, a closed type melt-kneading machine is preferably used. The temperature of the dynamic crosslinking is usually 150 to 250° C. and the time of the dynamic crosslinking is usually 1 to 30 minutes.

The content of the ethylene-α-olefin copolymer rubber is preferably 20 to 60% by weight, more preferably 30 to 50% by weight. The content of the propylene resin is preferably 10 to 30% by weight, more preferably 20 to 30% by weight. The content of the mineral oil is preferably 10 to 50% by weight, more preferably 20 to 40% by weight. It is noted that the total content of the ethylene-α-olefin copolymer rubber, the propylene resin and the mineral oil is 100% by weight. The content of the ethylene resin is preferably 0 to 5 parts by weight, provided that the total content of the ethylene-α-olefin copolymer rubber, the propylene resin and the mineral oil is 100 parts by weight.

The content of the high density polyethylene is preferably 60 to 120 parts by weight, more preferably 65 to 100 parts by weight, further preferably 70 to 90 parts by weight, provided that the content of the ethylene-α-olefin copolymer rubber in the thermoplastic elastomer is 100 parts by weight.

The thermoplastic elastomer composition may be produced by, for example, (1) a method including dynamically crosslinking an ethylene-α-olefin copolymer rubber, a propylene resin, mineral oil and an ethylene resin in the presence of a crosslinking agent to obtain a thermoplastic elastomer, and melt-kneading the thermoplastic elastomer with a high density polyethylene using a conventional melt-kneading machine such as a Banbury mixer, an extrusion kneader or an open roll; and (2) a method including dynamically crosslinking ethylene-α-olefin copolymer rubber, a propylene resin, mineral oil and an ethylene resin in the presence of a crosslinking agent using an extrusion kneader or the like having a plurality of material feed openings on an upstream side of the extrusion kneader to obtain a thermoplastic elastomer, and melt-kneading, on a downstream side of the extrusion kneader, the thermoplastic elastomer with a high density polyethylene supplied through a feed opening disposed on the downstream side of the extrusion kneader. The temperature of the melt-kneading is usually 150 to 250° C. and the time of the melt-kneading is usually 1 to 30 minutes.

The thermoplastic elastomer composition may include, if necessary, an additive such as a filler, a UV absorber, a light stabilizer, an antioxidant, a releasing agent or a pigment. The additive may be added before or after the dynamic crosslinking.

Examples of the filler include carbon black, clay, talc, calcium carbonate, kaolin, diatomite, silica, alumina, graphite and glass fiber.

Examples of the releasing agent include fatty amide, silicone oil, glycerin and wax.

### Composite Molded Body

The composite molded body of the present invention includes a molded body made of the thermoplastic elastomer composition and a vulcanized rubber molded body jointed to each other.

The vulcanized rubber molded body may be produced by molding and vulcanizing a material rubber component by a conventional method. The vulcanized rubber molded body including a resin component, an additional component such as a reinforcement, mineral oil, a processing aid, and an antioxidant or both of these in addition to the material rubber component may be produced by kneading the material rubber component, the resin component and the additional component using an internal mixer (for example, a Banbury mixer, a kneader or an intermix apparatus) or an open roll to obtain a composition, molding and vulcanizing the composition by a conventional method. The content of the reinforcement is 50 to 150 parts by weight. The content of the resin component is usually not more than 20 parts by weight, preferably not more than 10 parts by weight, provided that the content of the material rubber component is 100 parts by weight.

The molding and vulcanization is performed, for example, by (1) a method in which the vulcanization is performed simultaneously with the molding of a composition by a molding method such as press molding, injection molding or transfer molding, (2) a method in which a composition is molded into a molded article in a prescribed shape by a molding method such as extrusion molding or calendar roll molding and the molded article is vulcanized in an apparatus such as a glass bead fluid bed or an LCM (thermally molten salt bath), in hot air or in vapor, or (3) a method in which a material rubber component or a composition is molded into a molded article in a prescribed shape by the molding method such as the extrusion molding or the calendar roll molding and the thus obtained molded article is vulcanized by irradiating with UHF (ultra high frequency electromagnetic microwaves) or electron beams.

Examples of the material rubber component used for the vulcanized rubber molded body include ethylene-α-olefin copolymer rubber, natural rubber, isoprene rubber, butadiene rubber, styrene-butadiene copolymer rubber, acrylonitrile-butadiene copolymer rubber and butyl rubber, preferably ethylene-α-olefin copolymer rubber, and any of those described above as the examples of the material for the thermoplastic elastomer may be used. Among these, ethylene-propylene copolymer rubber or ethylene-propylene-5-ethylidene-2-norbornene copolymer rubber is more preferable. The ethylene-α-olefin copolymer rubber has an ethylene content of preferably 50 to 75% by weight, more preferably 60 to 70% by weight, provided that the content of the ethylene-α-olefin copolyymer rubber is 100 parts by weight.

When a vulcanizing agent is used in the vulcanization, examples of the vulcanizing agent include an organic peroxide, a phenol resin, sulfur, a sulfur-containing compounds p-quinone, a derivative of p-quinonedioxime, a bismaleimide compound, an epoxy compound, a silane compound and an amino resin, preferably sulfur and a sulfur-containing compound.

In the vulcanization, a vulcanization accelerator may be used. Examples of the vulcanization accelerator include aldehyde-amines such as n-butyl aldehyde and aniline condensate, and butyl aldehyde and monobutyl amine condensate; guanidines such as diphenyl guanidine and di-ortho-tolylguanidine; thiazole-based substances such as 2-mercaptobenzothiazole, dibenzothiazyl disulfide and 2-(2,4-dinitrophenyl) mercaptobenzothiazole; sulfenamides such as N-cyclohexyl-2-benzothiazyl sulfenamide; thiurams such as tetramethylthiuram disulfide, tetraethylthiuram disulfide and tetramethylthiuram monosulfide; thioureas such as ethylene thiourea and N-N′-diphenyl thiourea; dithiocarbamates such as zinc dimethyldithiocarbamate, zinc diethyldithiocarbamate and zinc dibutyldithiocarbamate; and xanthates such as zinc dibutyl xanthate.

The vulcanized rubber molded body may be in the form of foam.

Examples of a foaming agent used in the production of the foam include an inorganic foaming agent such as sodium acid carbonate (baking soda), sodium carbonate, ammonium bicarbonate, ammonium carbonate or ammonium nitrite; a nitroso compound such as N,N′-dimethyl-N,N′-dinitroso terephthalamide or N,N′-dinitroso pentamethylene tetramine (OPT); an azo compound such as azodicarbonamide (ADCA), azobisisobutyronitrile (AZBN), azobiscyclohexylnitrile, azodiaminobenzene or barium azodicarboxylate; a sulfonyl hydrazide compound such as benzenesulfonyl hydrazide (BSH), toluenesulfonyl hydrazide (TSH), p,p′-oxybis(benzenesulfonyl hydrazide) (OBSH) or diphenylsulfone-3,3′-disulfonyl hydrazide, and an azide compound such as calcium azide, 4,4-diphenyldisulfonyl azide and p-toluenesulfonyl azide.

The vulcanized rubber molded body may include a reinforcement, mineral oil, a processing aid, and an antioxidant.

Examples of the reinforcement include carbon black and silica.

Examples of the mineral oil include those described above as the exemplified materials for the thermoplastic elastomer.

Examples of the processing aid include ricinolic acid, stearic acid, palmitic acid, lauric acid, barium stearate, zinc stearate and calcium stearate.

Examples of the antioxidant include an aromatic secondary amine-based antioxidant such as phenylbutyl amine or N,N-di-2-naphthyl-p-phenylene diamine; a phenol-based antioxidant such as dibutyl hydroxytoluene or pentaerythrityl tetrakis [3-(3,5-di-t-butyl-4-hydroxyphenyl)propionate]; a thioether-based antioxidant such as bis[2-methyl-4-(3-n-alkylthiopropionyloxy)-5-t-butylphenyl] sulfide; dithiocarbamate-based antioxidant such as nickel dibutyldithiocarbamate; and a sulfur-based antioxidant such as 2-mercaptobenzoylimidazole, zinc salt of 2-mercaptobenzoimidazole, dilaurylthiodipropionate or distearylthiodipropionate.

The vulcanized rubber molded body may include a resin component. Examples of the resin component include polyethylene, polypropylene, 1,2-polybutadiene and polybutene.

The composite molded body is suitably used as an automobile exterior component. Examples of the automobile exterior component include a weather strip including a bar-shaped member made of a vulcanized rubber molded body and a corner member made of an olefin thermoplastic elastomer composition fused to each other, and a door trim including a skin layer of an olefin thermoplastic elastomer molded body fused on a substrate layer of a vulcanized rubber molded body. In particular, the composite molded body suitably includes a bar-shaped member made of a vulcanized rubber molded body and a corner member made of an olefin thermoplastic elastomer composition.

The composite molded body may be produced by, for example, a method in which a vulcanized rubber molded body molded is charged into a die and a thermoplastic elastomer composition is injected into the die so as to joint the vulcanized rubber molded body and the thermoplastic elastomer composition to each other, or a method in which a thermoplastic elastomer composition is melt extruded onto and jointed to a vulcanized rubber molded body.

The weather strip may be produced by, for example, an insert molding in which a vulcanized rubber is extrusion molded into a bar shape and cut in a prescribed length to obtain a vulcanized rubber molded body, and the vulcanized rubber molded body is charged into a die from different directions, and then a thermoplastic elastomer composition is injected into the die so as to be fused with the vulcanized rubber molded body.

The thermoplastic elastomer composition is good at adhesion to vulcanized rubber,

### EXAMPLES

### [Measurement of Physical Properties]

The physical properties were measured as follows:
1. Mooney Viscosity (ML₁₊₄)

The Mooney viscosity was measured in accordance with JIS K6300. ML₁₊₄ 100° C. was measured at a temperature of 100° C., and ML₁₊₄ 125° C. was measured at a temperature of 125° C.
2. Melt Flow Rate (MFR)

The melt flow rate was measured in accordance with JIS K7210. It is noted that the measurement for a propylene resin was performed at a temperature of 230° C. under load of 21.18 N and that for an ethylene resin was performed at a temperature of 190° C. under load of 21.18 N.
3. Ethylene content, Propylene content, 5-ethylidene-2-norbornene (hereinafter referred to as “ENB”) content

These contents were measured by infrared spectroscopy.
4. Density

The density was measured in accordance with JIS K7112.
5. Hardness

The durometer JIS-A hardness was measured in accordance with JIS K6253.
6. Compression Set

The compression set was measured in accordance with JIS K6262 under conditions of 70° C., 25% compression and 22 hours.
7. Tensile Strength and Elongation

The measurement was performed in accordance with JIS K6251 using a JIS No. 3 test piece at a tensile speed of 200 mm/min. for measuring tensile strength and elongation attained when broken.

### Example 1

### [Preparation of Vulcanized Rubber Sheet]

Hundred parts by weight of ethylene-propylene-5-ethylidene-2-norbornene copolymer rubber (manufactured by Sumitomo Chemical Co., Ltd., trade name: Esprene 522, ML₁₊₄125° C.:85, ethylene content: 55% by weight, ENB content: 4% by weight), 10parts by weight of zinc oxide (manufactured by Sakai Chemical Industry Co., Ltd., trade name: Zinc oxide JIS 2), 3 parts by weight of stearic acid (manufactured by ADEKA Corporation, trade name: Adeka fatty acid SA-400), 100 parts by weight of MAF carbon (manufactured by Tokai Carbon Co., Ltd., trade name: Seast 116) and 60 parts by weight of paraffinic process oil (manufactured by Idemitsu Kosan Co., Ltd., trade name: Diana PW380) were charged in a Banbury mixer with a temperature of the mixer set to 70° C. and were melt-kneaded for 5 minutes.

The final temperature of the mixer was 160° C.

Then, 273 parts by weight of the obtained mixture, 5 parts by weight of calcium oxide (manufactured by Inoue Calcium Co., Ltd., trade namer Vesta PP), 0.625 part by weight of a vulcanization accelerator, tetramethylthiuram disulfide (manufactured by Rhein Chemie Corporation, trade name: Rhenogran TM TD80), 2.5 parts by weight of a vulcanization accelerator, zinc dibutyldithiocarbamate (manufactured by Rhein Chemie Corporation, trade name: Rhenogran ZD BC80), 1.88 parts by weight of a vulcanization accelerator, 2-mercaptobenzothiazole (manufactured by Rhein Chemie Corporation, trade name: Rhenogran MB T80), 1.25 parts by weight of a vulcanization accelerator, ethylene thiourea (manufactured by Rhein Chemie Corporation, trade name: Rhenogran ETU80) and 1.5parts by weight of sulfur (manufactured by Hosoi Chemical Industry Co., Ltd., trade name: Sulfur 200M) were kneaded with a roll at a temperature of 40° C. for 10 minutes, so as to obtain an unvulcanized rubber composition.

The thus obtained unvulcanized rubber composition was subjected to a heat treatment at 160° C. for 30 minutes by using a press molding machine, so as to obtain a vulcanized rubber sheet (thereinafter, referred to as “vulcanized rubber sheet 1”) having a thickness of 2 mm.

### [Preparation of Thermoplastic Elastomer Composition]

A thermoplastic elastomer was obtained by dynamically crosslinking the following at 200±10° C. by using a two-axis extruder:

75 parts by weight of oil extended ethylene-propylene-5-ethylidene-2-norbornene copolymer rubber having a ML₁₊₄ 100° C. of 53, 100 parts by weight of a ethylene-propylene-5-ethylidene-2-norbornene copolymer rubber (ethylene content: 62.0 % by weight, propylene content: 28.1% by weight, ENB content: 9.9% by weight), and 100 parts by weight of extended oil (manufactured by Idemitsu Kosan Co., Ltd., trade name: PW-380); hereinafter referred to as “EPDM-1”);

25 parts by weight of a polypropylene resin having a MFR (230° C., 21.18 N) of 0.7 g/10 min.; hereinafter referred to as “PP”);

0.1 part by weight of a phenol-based antioxidant (manufactured by Ciba Specialty Chemicals Corporation, trade name: Irganox 1010);

0. 2 part by weight of a diazo-based light stabilizer (manufactured by Sumitomo Chemical Co., Ltd., trade name: Sumisorb 300);

0.2 part by weight of a HALS-based light stabilizer (manufactured by Ciba Specialty Chemicals Corporation, trade name: Tinuvin 622);

3.2 parts by weight of an organic peroxide (2,5-dimethyl-2,5-di(t-butylperoxy) hexane, manufactured by Kayaku Akzo Corporation, trade name: APO-10DL, was diluted into 10% with paraffinic oil, manufactured by Idemitsu Kosan Co., Ltd., trade name: PW-100); and

0.1 part by weight of a crosslinking assistant (manufactured by Sumitomo Chemical Co., Ltd., trade name: Sumifine BM).

A thermoplastic elastomer composition was obtained by blending 100 parts by weight of the thus obtained thermoplastic elastomer and 30 parts by weight of high density polyethylene (density: 961 kg/m³, MFR(190° C., 21.18 N); 12 g/10 min.; hereinafter referred to as “HDPE-1”) and by granulating the blended substance with a 30 mm one-axis extruder. The content of the HDPE-1 was 80 parts by weight, based on 100 parts by weight of the rubber component of EPDM-1. The result was shown in Table 1.

### [Molding of Composite Molded Body]

The vulcanized rubber sheet 1 was charged in a die of 150×90×2 mmt, and the thermoplastic elastomer composition was injected into the die by an injection molding machine under conditions of a cylinder temperature of 250° C. and a die temperature of 50° C., so as to obtain a molded body including the vulcanized rubber sheet 1 and the thermoplastic elastomer jointed to each other by the insert molding. The molded body was punched out with a JIS No. 3 dumbbell and pulled at a rate of 200 mm/min. for evaluating the adhesion strength. The result was shown in Table 1.

### Example 2

Except that high density polyethylene with a density of 964 kg/m³ and MFR (190° C., 21.18 N) of 5.2 g/10 min. (hereinafter referred to as “HDPE-2”) was used as the high density polyethylene in the step of preparing a thermoplastic elastomer composition the same operations as Example 1 were performed. The result was shown in Table 1.

### Comparative Example 1

Except that the thermoplastic elastomer was not blended with the HDFE-1 but the thermoplastic elastomer was used instead of the thermoplastic elastomer composition for molding a composite molded body, the same operations as Example 1 were performed. The result was shown in Table 1.

### Comparative Example 2

Except that linear low density polyethylene (density: 913 kg/m³, MFR (190° C., 21.18 N): 3.8 g/10 min.; hereinafter referred to as the LLDPE) was used instead of the high density polyethylene, the same operations as Example 1 were performed. The result was shown in Table 1.

### Comparative Example 3

A thermoplastic elastomer was obtained by dynamically crosslinking the following at 200±10° C. by using a two-axis extruder:

57.7 parts by weight of EPDM-1;

19.2 parts by weight of PP;

23.2 parts by weight of HDPE-1;

0.1 part by weight of a phenol-based antioxidant (manufactured by Ciba Specialty Chemicals Corporation, trade name: Irganox 1010);

0.2 part by weight of a diazo-based light stabilizer (manufactured by Sumitomo Chemical Co., Ltd., trade name: Sumisove 300);

0.2 part by weight of a HALS-based light stabilizer (manufactured by Ciba Specialty Chemicals Corporation, trade name: Tinuvin 622);

3.2 parts by weight of an organic peroxide (manufactured by Kayaku Akzo Corporation, trade name; APO-10DL); and

0.1 part by weight of a crosslinking assistant (manufactured by Sumitomo Chemical Co., Ltd., trade name: Sumifine BM).

A vulcanized rubber sheet 1 prepared in the same manner as in Example 1 was charged in a die, and a thermoplastic elastomer composition was injected into the die by an injection molding machine under conditions of a cylinder temperature of 250° C. and a die temperature of 50° C., so as to obtain a molded body including the vulcanized rubber sheet 1 and the thermoplastic elastomer jointed to each other by the insert molding. The molded body was punched out with a JIS No. 3 dumbbell and pulled at a rate of 200 nm/min. for evaluating the adhesion strength. The result was shown in Table 1.

TABLE 1

| | | | | Comp. | Comp. | Comp. |
|---|---|---|---|---|---|---|
| | | Ex. 1 | Ex. 2 | Ex. 1 | Ex. 2 | Ex. 3 |
| Composition | parts by | | | | | |
| | weight | | | | | |
| Thermoplastic | | 100 | 100 | 100 | 100 | 100 |
| elastomer | | | | | | |
| (EPDM-1) | | (75) | (75) | (75) | (75) | (57.7) |
| (PP) | | (25) | (25) | (25) | (25) | (19.2) |
| (HDPE-1) | | (—) | (—) | (—) | (—) | (23.1) |
| HDPE-1 | | 30 | — | — | — | — |
| | | (80) *1 | | | | |
| HDPE-2 | | — | 30 | — | — | — |
| | | | (80) *1 | | | |
| LLDPE | | — | — | — | 30 | — |
| | | | | | (80) *1 | |
| Physical | | | | | | |
| properties | | | | | | |
| Hardness | — | 93 | 93 | 83 | 89 | 93 |
| Compression | % | 39 | 34 | 40 | 44 | 35 |
| set | | | | | | |
| Tensile | MPa | 9.4 | 10.4 | 9.1 | 10.3 | 9.4 |
| strength | | | | | | |
| Elongation | % | 500 | 500 | 560 | 500 | 300 |
| Adhesion | | | | | | |
| adherend | — | *2 | *2 | *2 | *2 | *2 |
| strength | MPa | 4.4 | 4.5 | 3.0 | 3.8 | 3.8 |

*1 the content (parts by weight) of HDPE-1, HDPE-2 or LLDPE, provided that the content of the rubber component of EPDM-1 was 100 parts by weight
*2 Vulcanized rubber sheet 1

### Example 3

### [Preparation of Vulcanized Rubber Sheet]

Except that ethylene-propylene-5-ethylidene-2-norbornene copolymer rubber (manufactured by Sumitomo Chemical Co., Ltd., trade name: Esprene 512F, ML₁₊₄ 125° C.66, ethylene content: 65% by weight, ENB content: 4% by weight) was used instead of the ethylene-propylene-5-ethylidene-2-norbornene copolymer rubber of Example 1, the same operations as [Preparation of vulcanized rubber sheet] of Example 1 were performed to obtain a vulcanized rubber sheet (thereinafter, referred to as “vulcanized rubber sheet 2”) having a thickness of 2 mm.

### [Molding of Composite Molded Body]

The vulcanized rubber sheet 2 was charged in a die of 150×90×2 mmt, and the thermoplastic elastomer composition prepared by the same method as [Preparation of thermoplastic elastomer composition] of Example 1 was injected into the die by an injection molding machine under conditions of a cylinder temperature of 250° C. and a die temperature of 50° C., so as to obtain a molded body including the vulcanized rubber sheet 2 and the thermoplastic elastomer jointed to each other by the insert molding. The molded body was punched out with a JIS No. 3 dumbbell and pulled at a rate of 200 mm/min. for evaluating the adhesion strength. The result was shown in Table 2.

### Example 4

Except that a thermoplastic elastomer prepared by the same method as [Preparation of thermoplastic elastomer composition] of Example 2 was used instead of the thermoplastic elastomer composition in [Molding of composite molded body] of Example 3, the same operations as Example 3 were performed. The result was shown in Table 2.

### Example 5

### [Preparation of Vulcanized Rubber Sheet]

Except that ethylene-propylene-5-ethylidene-2-norbornene copolymer rubber (manufactured by Sumitomo Chemical Co., Ltd., trade name; Esprene 505, ML₁₊₄ 125° C.:59, ethylene content: 50% by weight, ENS content: 10% by weight) was used instead of the ethylene-propylene-5-ethylidene-2-norbornene copolymer rubber of Example 1, the same operations as [Preparation of vulcanized rubber sheet] of Example 1 were performed to obtain a vulcanized rubber sheet (thereinafter, referred to as “vulcanized rubber sheet 3”) having a thickness of 2 mm.

### [Molding of Composite Molded Body]

The vulcanized rubber sheet 3 was charged in a die of 150×90×2 mmt, and the thermoplastic elastomer composition prepared by the same method as [Preparation of thermoplastic elastomer composition] of Example 1 was injected into the die by an injection molding machine under conditions of a cylinder temperature of 250° C. and a die temperature of 50° C., so as to obtain a molded body including the vulcanized rubber sheet 3 and the thermoplastic elastomer jointed to each other by the insert molding. The molded body was punched out with a JIS No. 3 dumbbell and pulled at a rate of 200 mm/min. for evaluating the adhesion strength. The result was shown in Table 2.

### Example 6

Except that a thermoplastic elastomer prepared by the same method as [Preparation of thermoplastic elastomer composition] of Example 2 was used instead of the thermoplastic elastomer composition in [Molding of composite molded body] of Example 5, the same operations as Example 5 were performed The result was shown in Table 2.

TABLE 2

| | | | |
|---|---|---|---|
| Ex. 3 | Ex. 4 | Ex. 5 | Ex. 6 |

| | | | | | |
|---|---|---|---|---|---|
| Composition | parts by | | | | |
| | weight | | | | |
| Thermoplastic | | 100 | 100 | 100 | 100 |
| elastomer | | | | | |
| (EPDM-1) | | (75) | (75) | (75) | (75) |
| (PP) | | (25) | (25) | (25) | (25) |
| (HDPE-1) | | (—) | (—) | (—) | (—) |
| HDPE-1 | | 30 | — | 30 | — |
| | | (80) *1 | | (80) *1 | |
| HDPE-2 | | — | 30 | — | 30 |
| | | | (80) *1 | | (80) *1 |
| Physical properties | | | | | |
| Hardness | — | 93 | 93 | 93 | 93 |
| Compression set | % | 39 | 34 | 39 | 34 |
| Tensile strength | MPa | 9.4 | 10.4 | 9.4 | 10.4 |
| Elongation | % | 500 | 500 | 500 | 500 |
| Adhesion | | | | | |
| adherend | — | *2 | *2 | *3 | *3 |
| strength | MPa | 4.6 | 4.7 | 4.2 | 4.2 |

*1 the content (parts by weight) of HDPE-1, or HDPE-2, provided that the content of the rubber component of EPDM-1 was 100 parts by weight
*2 vulcanized rubber sheet 2
*3 vulcanized rubber sheet 3

### Example 7

Except that the content of HDPE-1 was changed into 26.3 parts by weight in [Preparation of thermoplastic elastomer composition] of Example 1, the same operation as Example 1 was performed. The content of the HDPE-1 was 70 parts by weight, based on 100 parts by weight of the rubber component of EPDM-1. The result was shown in Table 3.

### Example 8

Except that the content of HDPE-1 was changed into 22.5 parts by weight in [Preparation of thermoplastic elastomer composition] of Example 1, the same operation as Example 1 was performed. The content of the HDPE-1 was 60 parts by weight, based on 100 parts by weight of the rubber component of EPDM-1. The result was shown in Table 3.

### Comparative Example 4

Except that the content of HDPE-1 was changed into 18.8 parts by weight in [Preparation of thermoplastic elastomer composition] of Example 1, the same operation as Example 1 was performed. The content of the HDPE-1 was 50 parts by weight, based on 100 parts by weight of the rubber component of EPDM-1. The result was shown in Table 3.

TABLE 3

| | | | | Comp. |
|---|---|---|---|---|
| | | Ex. 7 | Ex. 8 | Ex. 4 |
| Composition | parts by | | | |
| | weight | | | |
| Thermoplastic | | 100 | 100 | 100 |
| elastomer | | | | |
| (EPDM-1) | | (75) | (75) | (75) |
| (PP) | | (25) | (25) | (25) |
| (HDPE-1) | | (—) | (—) | (—) |
| HDPE-1 | | 26.3 | 22.5 | 18.8 |
| | | (70) *1 | (60) *1 | (50) *1 |
| Physical | | | | |
| properties | | | | |
| Hardness | — | 93 | 92 | 92 |
| Compression set | % | 39 | 39 | 40 |
| Tensile strength | MPa | 9.4 | 9.2 | 9.3 |
| Elongation | % | 490 | 500 | 500 |
| Adhesion | | | | |
| adherend | — | *2 | *2 | *2 |
| strength | MPa | 4.4 | 4.3 | 3.9 |

*1 the content (parts by weight) of HDPE-1, provided that the content of the rubber component of EPDM-1 was 100 parts by weight
*2 vulcanized rubber sheet 1

### INDUSTRIAL APPLICABILITY

The present invention provides a thermoplastic elastomer composition with excellent adhesion to vulcanized rubber. The thermoplastic elastomer composition exhibits a good compression set, high tensile strength and high elongation. The thermoplastic elastomer composition is used for a composite molded body including a molded body made of the thermoplastic elastomer composition and a vulcanized rubber molded body jointed to each other. The composite molded body is suitably used for automobile interior and exterior material such as weather strip.

1. A thermoplastic elastomer composition comprising the following (i) and (ii):
(i) a thermoplastic elastomer obtained by dynamically crosslinking (a), (b), (c) and (d) in the presence of a crosslinking agent,
(a) 10 to 75% by weight of the ethylene-α-olefin copolymer rubber;
(b) 10 to 50% by weight of a propylene resin;
(c) 5 to 60% by weight of mineral oil; and
(d) an ethylene resin;
a total content of (a), (b) and (c) being 100% by weight, and a content of (d) being from 0 to 10 parts by weight, provided that the total content of (a), (b) and (c) is 100 parts by weight;
(ii) a high density polyethylene; and
a content of (ii) high density polyethylene is from 55 to 150 parts by weight based on 100 parts by weight of (a) the ethylene-α-olefin copolymer rubber.

2. The thermoplastic elastomer composition of claim 1, wherein the crosslinking agent is an organic peroxide.

3. A composite molded body comprising a molded body made of the composition of claim 1 and a vulcanized rubber molded body jointed to each other.

4. A weather strip comprising a molded body made of the composition of claim 1 and a vulcanized rubber molded body jointed to each other.

5. A composite molded body comprising a molded body made of the composition of claim 2 and a vulcanized rubber molded body jointed to each other.

6. A weather strip comprising a molded body made of the composition of claim 2 and a vulcanized rubber molded body jointed to each other.
